(19) United States
(12) Patent Application Publication
(10) Pub. No.: US 2004/0224571 A1
(43) Pub. Date: Nov. 11, 2004

(54) Terminal structure having improved electroplate

(76) Inventor: Sheng-Hsing Yeh, Shijr City (TW)

Correspondence Address: TROXELL LAW OFFICE PLLC, SUITE 1404, 5205 LEESBURG PIKE, FALLS CHURCH, VA, 22041, US

(21) Appl. No.: 10/623,536

(22) Filed: Jul. 22, 2003

(30) Foreign Application Priority Data
Apr. 25, 2003 (TW) 092206642

(51) Int. Cl. H01R 13/24

(52) U.S. Cl. 439/824

(57) ABSTRACT

The present invention provides a terminal structure having an improved electroplate. The terminal is configured to a circuit board for contacting an electrode of an external battery. The terminal is formed with a hollow-tube body having a base, wherein an opening is formed in an end of the hollow-tube body; a contacting portion disposed in the hollow-tube body; and an elastic member disposed between the hollow-tube body and the contacting portion. A bore passing through the hollow-tube body is disposed in circumference of the hollow-tube body and is close to the base. Whereby when being electroplated in electroplating solution, by convection of the electroplating solution between the opening and the bore in the hollow-tube body, inner and outer parts of the hollow-tube body are electroplated thoroughly.

### FIELD OF THE INVENTION

The present invention relates to a terminal structure having improved electroplate. More particularly, when being electroplated in an electroplating solution, by convection of the electroplating solution between an opening and a bore in the hollow-tube body, inner and outer parts of the hollow-tube body are electroplated thoroughly.

### BACKGROUND OF THE INVENTION

The conventional terminal structure is generally formed with a bushing and a contacting portion. Also, a spring is disposed between the bushing and the contacting portion. A closed side and an opening are respectively disposed in two ends of the bushing. By the closed side mounting in a circuit board, the terminal structure is capable of contacting an electrode of an external battery.

Although the above-mentioned terminal structure can be mounted in the circuit board for contacting the electrode of the external battery, however, the terminal structure must be electroplated before being fabricated. In the electroplating process, devices need to be electroplated in a container full of electroplating solution. Since the opening is in one end of the bushing and the closed side is in another end of the bushing, during the electroplating process, inner and outer pressures will be different, causing the electroplating solution not able to completely enter the bushing. Therefore, the inner part of the bushing can not be electroplated thoroughly. That is, some inner parts of the bushing may be electroplated but other parts may not. In using, the electronic efficiency will become worse due to incomplete electroplating of the terminal. Therefore, the conventional terminal structure mentioned above can not meet realistic needs.

### SUMMARY OF THE INVENTION

The main objective of the present invention is that when being electroplated in an electroplating solution, by convection of the electroplating solution via an opening and a bore in the hollow-tube body, inner and outer parts of the hollow-tube body are electroplated thoroughly.

To achieve the above objective, the terminal of the present invention is configured to a circuit board for contacting an electrode of an external battery, which comprises:

a hollow-tube body having a base disposed in an end, wherein an opening with a gradually narrow figure is formed in an end of the hollow-tube body;

a contacting portion disposed within the mentioned hollow-tube body, wherein a stopper is circularly disposed in an end of the contacting portion, the stopper causes obstruction in the opening of the hollow-tube body, a recession is disposed in an end of the stopper;

an elastic member disposed between the hollow-tube body and the contacting portion, wherein an end of the elastic member withstands the base in the end of the hollow-tube body and another end of the elastic member withstands the recession of the stopper;

which is characterized in that:

a bore is disposed in circumference of the hollow-tube body and is close to the base, the bore passes through the hollow-tube body; whereby when being electroplated in an electroplating solution, by convection of the electroplating solution via an opening and a bore in the hollow-tube body, inner and outer parts of the hollow-tube body are electroplated thoroughly.

### BRIEF DESCRIPTION OF THE DRAWINGS

The present invention will be better understood from the following detailed description of preferred embodiments of the invention, taken in conjunction with the accompanying drawing, in which:

FIG. 1 is a view showing the outward appearance of the present invention;

FIG. 2 is a view showing a separation view of the present invention;

FIG. 3 is a view showing a cross-section view of the present invention; and

FIG. 4 is a cross-section view in an electroplating configuration of the present invention.

### DETAIL DESCRIPTION OF THE INVENTION

The following descriptions of the preferred embodiments are provided to understand the features and the structures of the present invention.

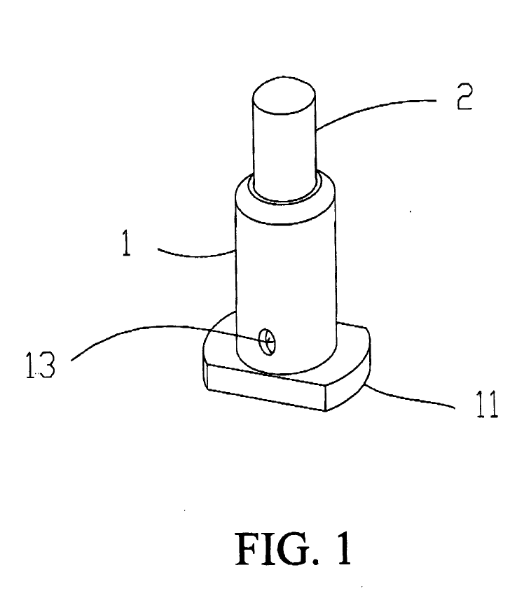

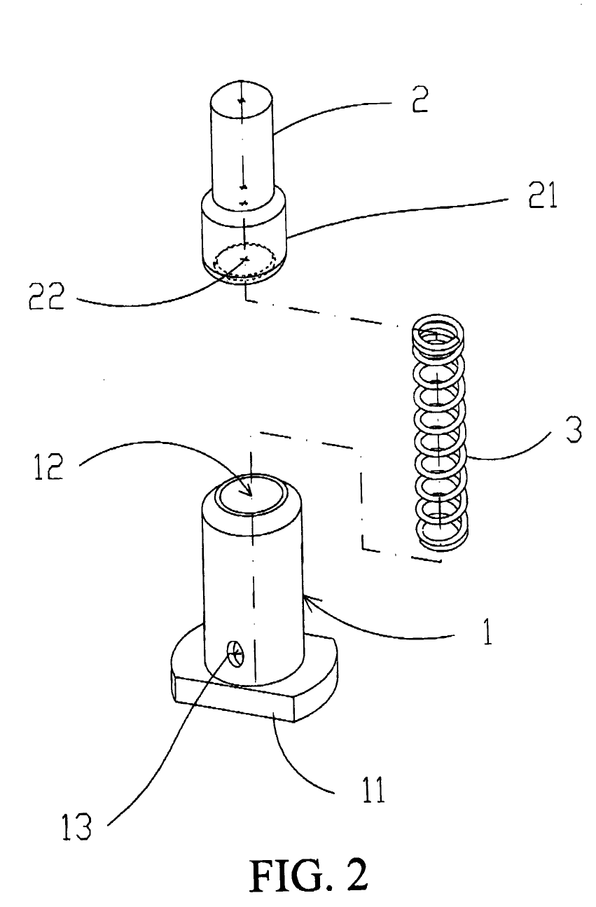

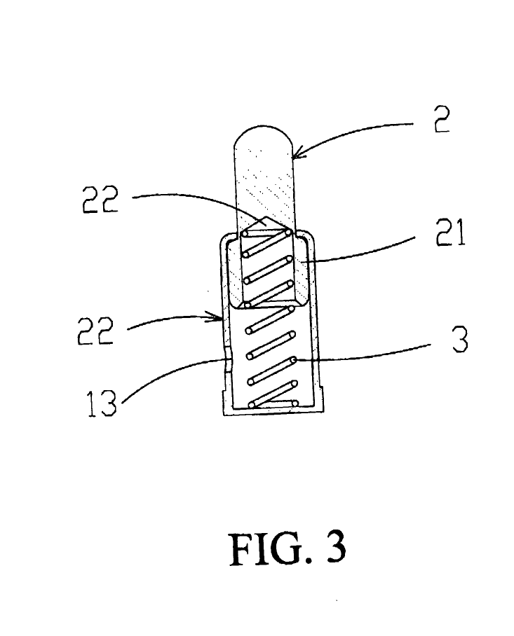

FIG. 1, FIG. 2 and FIG. 3 are respectively a view showing the outward appearance of the present invention, a separation view of the present invention, and a cross-section view of the present invention. As shown in the drawings, the present invention is a terminal structure having improved electroplate. The terminal is configured to a circuit board for contacting an electrode of an external battery (not shown), which comprises:

a hollow-tube body 1 having a base 11 disposed in an end, wherein an opening 12 with a gradually narrow figure is formed in an end of the hollow-tube body 1. Moreover, a bore 13 is disposed in circumference of the hollow-tube body 1 and is close to the base 11. The bore 13 passes through the hollow-tube body 1;

a contacting portion 2 disposed within the mentioned hollow-tube body 1, wherein a stopper 21 is circularly disposed in an end of the contacting portion 2 and the end of the contacting portion 2 is partially exposed out from the opening 12 of the hollow-body tube 1. The stopper 21 causes obstruction in the opening 12 of the hollow-tube body 1 with a gradually narrow figure, and thus a recession 22 is disposed in an end of the stopper 21;

an elastic member 3 disposed between the hollow-tube body 1 and the contacting portion 2, wherein an end of the elastic member 3 withstands the base 11 in the end of the hollow-tube body 1 and another end of the elastic member 3 withstands the recession 22 of the stopper 21. By the elastic member 3, the contacting portion 2 can expand and contract in an end of the hollow-tube body 1; Therefore, a novel terminal structure is provided. By it, when being electroplated in an electroplating solution, by convection of the electroplating solution between the opening 12 and the bore 13 in the hollow-tube body 1, inner and outer parts of the hollow-tube body 1 are electroplated thoroughly.

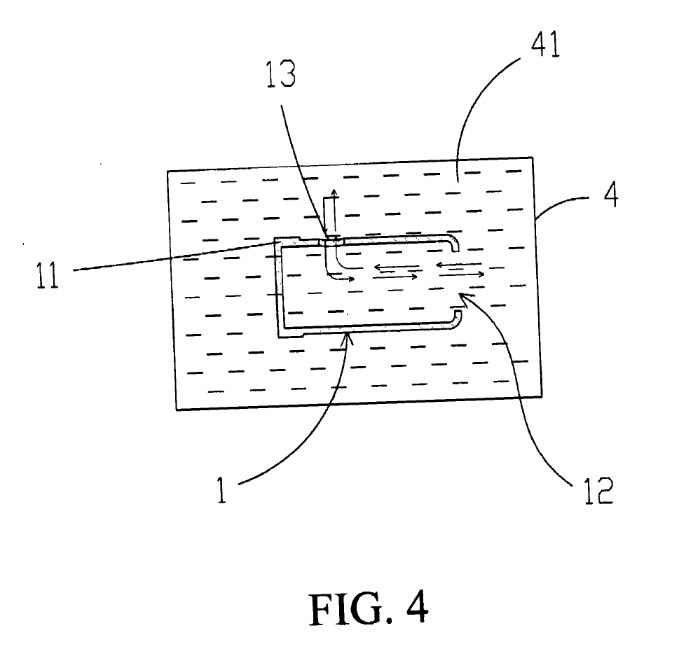

FIG. 4 is a cross-section view in an electroplating configuration of the present invention. As shown in the drawing, before being fabricated, the terminal structure of the present invention has to electroplate each device respectively. While electroplating, the hollow-tube body 1 is placed in an electroplating container 4 with the electroplating solution 41. For the time being, since the bore 13 passes through the hollow-tube body 1, the opening 12 and the bore 13 in the end of the hollow-tube body 1 are combined, and the inner and outer pressure of the hollow-tube body 1 are identical (equal to the pressure in the electroplating container). Thus, when electroplating the hollow-tube body 1 in the electroplating solution, by convection of the electroplating solution 41 between the opening 12 and the bore 13 in the hollow-tube body 1, inner and outer parts of the hollow-tube body 1 are electroplated thoroughly.

In summation of the foregoing section, the invention herein fully complies will all new patent application requirement and is hereby submitted to the patent bureau for review and the granting of the commensurate patent rights.

The present invention may be embodied in other specific forms without departing from the spirit of the essential attributes there of; therefore, the illustrated embodiment should be considered in all respects as illustrative and not restrictive, reference being made to the appended claims rather than to the foregoing description to indicate the scope of the invention.

What is claimed is:

1. A terminal structure having an improved electroplate, wherein said terminal is configured to a circuit board for contacting an electrode of an external battery, comprising:
a hollow-tube body having a base disposed in an end, wherein an opening with a gradually narrow figure is formed in an end of said hollow-tube body;
a contacting portion disposed within said hollow-tube body, wherein a stopper is circularly disposed in an end of said contacting portion, said stopper causes obstruction in said opening of said hollow-tube body, a recession is disposed in an end of said stopper;
an elastic member disposed between said hollow-tube body and said contacting portion, wherein an end of said elastic member withstands said base in said end of said hollow-tube body and another end of said elastic member withstands said recession of said stopper;
which is characterized in that:
a bore is disposed in circumference of said hollow-tube body and is close to said base, said bore passes through said hollow-tube body;
whereby when being electroplated in an electroplating solution, by convection of said electroplating solution between said opening and said bore in said hollow-tube body, inner and outer parts of said hollow-tube body are electroplated thoroughly.
